(19) United States
(12) Patent Application Publication
(10) Pub. No.: US 2012/0203957 A1
(43) Pub. Date: Aug. 9, 2012

(54) SOLID STATE MEMORY-BASED MASS STORAGE DEVICE USING OPTICAL INPUT/OUTPUT LINKS

(75) Inventor: Franz Michael Schuette, Colorado Springs, CO (US)

(73) Assignee: OCZ TECHNOLOGY GROUP INC., San Jose, CA (US)

(21) Appl. No.: 13/368,878

(22) Filed: Feb. 8, 2012

Related U.S. Application Data
(60) Provisional application No. 61/440,577, filed on Feb. 8, 2011.

(51) Int. Cl. G06F 12/02

(52) U.S. Cl. 711/103; 711/211; 711/E12.008; 711/E12.001

(57) ABSTRACT

A solid state memory-based mass storage device and a method of transferring data between a memory controller and at least one memory device of the mass storage device through optical input/output links that transmit multiplexed optical data signals between the memory device and controller.

### CROSS REFERENCE TO RELATED APPLICATIONS

This application claims the benefit of U.S. Provisional Application No. 61/440,577, filed Feb. 8, 2011, the contents of which are incorporated herein by reference.

### BACKGROUND OF THE INVENTION

The present invention generally relates to memory devices for use with computers and other processing apparatuses. More particularly, the invention relates to a solid state memory-based mass storage device that comprises at least one memory device, and preferably an array or stack of non-volatile memory devices, and uses optical interconnect technology to route data signals between the memory device and a memory controller.

Mass storage devices such as advanced technology attachment (ATA) drives and small computer system interface (SCSI) drives are rapidly adopting non-volatile memory technology, such as flash memory or another emerging non-volatile solid-state memory technology including phase change memory (PCM), resistive random access memory (RRAM), magnetoresistive random access memory (MRAM), ferromagnetic random access memory (FRAM), organic memories, or nanotechnology-based storage media such as carbon nanofiber/nanotube-based substrates. Currently the most common solid-state technology uses NAND flash memory components as inexpensive storage memory, often in a form commonly referred to as a solid-state drive (SSD).

Future implementations of solid state memory-based mass storage devices are no longer restricted by form factor limitations imposed by the special mechanical properties of hard disk drives. Form factors are being miniaturized, and the trend is toward elimination of redundant structures, for example, cable-interconnects, by implementing socketed designs in which storage media are plugged directly into a main board. It is understood that even the current 2.5 inch form factor for solid state drives is too large for this kind of integration with a motherboard. Therefore, other solutions similar to those realized in dual inline memory modules (DIMM) are being pursued. As used in system memory, DIMMS interface with the system through a 64-bit wide parallel bus and, as such, they require typically several hundred pins to accommodate data, command, and address signals along with the necessary power and ground connectivity. Because each pin has a minimum required footprint or pitch, DIMMs are fairly wide and take up valuable real estate on the motherboard. On the other hand, SATA devices use a serial protocol to interface the storage media with the system, and therefore only require a single pair of unidirectional low voltage differential signaling lines (LVDS) for each input and output. The remaining pins of a SATA device are for the delivery of power and ground, including electrostatic discharge. In so far, the footprint required for any interface socket is substantially smaller than that of a DIMM, which in turn allows for a much smaller device footprint.

Internally, solid state drives use a highly parallel data path organization. For example, in the case of NAND flash, each memory device (chip or component) has typically eight or sixteen input/output (I/O) pins. Typically eight I/Os are used for a channel and each controller uses a number of parallel channels (most commonly eight or ten) in parallel to access the NAND. Accordingly, the resulting number of I/O traces is at least sixty-four but it can be any integer multiple of I/O pins per memory device. Routing I/O traces on any printed circuit board requires a certain amount of real estate on the board. Moreover, traces need to be impedance and length-matched in order to avoid data skew across the parallel data lines.

In light of the above, it would be desirable to reduce internal data paths of mass storage devices that utilize solid state memory-based technology in order to simplify the design and reduce the footprint of such devices.

### BRIEF DESCRIPTION OF THE INVENTION

The current invention provides a solid state memory-based mass storage device having one or more memory devices connected to a memory controller through optical input/output links that transmit multiplexed optical data signals between the memory device(s) and controller, such that the number of connections can be minimized.

According to a first aspect of the invention, a solid state memory-based mass storage device includes a carrier board including a system interface connector for connecting the carrier board to a host system. The device further includes at least one memory device with parallel input/output data connections, a memory controller having input/output data connections through which the memory controller is connected to the parallel input/output data connections of the memory device, and an optical I/O link that connects the input/output data connections of the memory controller to the parallel input/output data connections of the memory device. The optical I/O link uses wavelength division multiplexing to transmit parallel multiplexed optical data signals across the optical I/O link, and the parallel multiplexed optical data signals are de-multiplexed to isolate individual optical data signals for each of the parallel input/output data connections of the memory device.

According to a second aspect of the invention, a solid state memory-based mass storage device includes a carrier board including a system interface connector for connecting the carrier board to a host system, a plurality of non-volatile memory devices each with parallel input/output data connections, and a memory controller having input/output data connections through which the memory controller is connected to the parallel input/output data connections of the memory devices. Means is provided for performing wavelength division multiplexing on parallel input/output optical data signals to generate parallel multiplexed optical data signals, and an optical I/O link connects the input/output data connections of the memory controller to the parallel input/output data connections of a group of the memory devices and transmits the parallel multiplexed optical data signals between the memory controller and the group of memory devices. The storage device further includes means for de-multiplexing the parallel multiplexed optical data signals associated with the group of memory devices, isolating individual optical data signals of the parallel multiplexed optical data signals, and distributing the individual optical data signals across parallel input/output data connections on the group of memory devices.

Other aspects of the invention include a method of transferring data between a memory controller and at least one memory device of a solid state memory-based mass storage device. The method includes converting a plurality of electrical output data signals generated by a first of the memory controller and the memory device into optical data signals at different wavelengths, multiplexing the optical data signals into wavelength division multiplexed signals, transferring the wavelength division multiplexed signals over an optical I/O link, de-multiplexing the wavelength division multiplexed signals into individual optical data signals, converting the individual optical data signals into electrical signals, and transmitting the electrical signals to a second of the memory controller and the memory device.

A technical effect of the invention is the use of multiplexed data signals in a manner that is capable of significantly reducing the number of data paths between memory devices and a memory controller of a mass storage device in comparison to conventional electrical data signaling using traces.

Other aspects and advantages of the invention will be better appreciated from the following detailed description.

### BRIEF DESCRIPTION OF THE DRAWINGS

FIG. 1 schematically represents a typical routing of the I/O (DQ) traces between two 8-bit wide memory devices and a memory controller of a solid state memory-based mass storage device in accordance with conventional prior art practices.

FIG. 2 schematically represents a 4-bit wide optical link between a memory device and a memory controller of a solid state memory-based mass storage device for transmitting wavelength division multiplexed signals in accordance with an embodiment of the invention.

FIG. 3 schematically represents a configuration similar to that represented in FIG. 1, but modified to include integrated optical transceivers on the memory devices and controller that are connected to an optical I/O link to route eight wavelength division multiplexed I/O signals between each memory device and a memory controller of a solid state memory-based mass storage device in accordance with another embodiment of the invention.

FIG. 4 schematically represents a three-dimensional memory structure comprising two memory devices in a clamshell configuration with an optical interface layer therebetween that is capable of combining two 8-bit wide data interfaces into a single optical I/O link in accordance with another embodiment of the invention.

FIG. 5 schematically represents a second clamshell configuration in accordance with another embodiment of the invention, and shows a stack of four clamshells that combines eight memory devices into a functional unit with four multiplexed data I/O links routed to a carrier board.

### DETAILED DESCRIPTION OF THE INVENTION

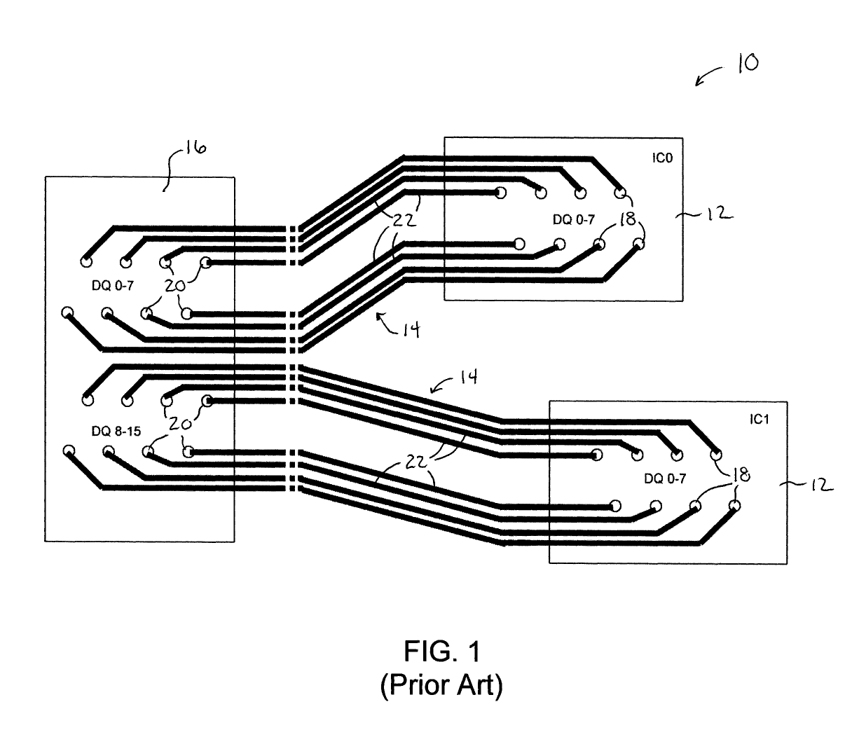

Conventional electrical signaling using electrically conductive traces has been the method of choice for transmitting signals in electronic systems, including computer systems. However, limitations of electrical signaling include the amount of real estate to accommodate the traces, electromagnetic interference and frequency limitations. Moreover, each trace typically only carries a single signal. An illustrative example is shown in FIG. 1, which schematically represents two memory devices 12 (IC0 and IC1), each having an 8-bit wide data channel 14 to a memory controller 16, for example, of a type that might be used in a solid state memory-based mass storage device 10. Each data input/output (I/O) pin 18 (DQ0-7) of either memory device 12 connects to a counterpart I/O pin 20 on the memory controller 16 using an individual data trace 22 of its channel 14, which results in a total of sixteen data traces 22 within the data path between the controller 16 and the memory devices 12. In the case of memory devices of a computer system, multiple banks can be connected to the same, shared, data path (bus). However, this has the drawback that only one bank can be active at any time. For a typical solid state mass storage device having independent channels 14 operating in parallel to each other for optimal utilization of the internal bandwidth, this arrangement is not advantageous. Rather, each memory device 12 needs its own independent set of data I/O traces 22.

Multiplexing is a commonly used method of reducing the number of data connections in electronic systems, including computer systems. As used herein, the term is used in the conventional sense to mean that one or more signal lines can carry several signals based on time division, code division or other domains. In telecommunications, optical signaling uses wavelength division multiplexing, which allows the simultaneous transmission of several signals across a single mode optical fiber, with their separation based on the specific wavelength of the optical signal. The most commonly used standards are coarse wavelength division multiplexing (CWDM) and dense wavelength division multiplexing (DWDM), depending on the width of the optical spectrum used.

In the broadest sense, optical signaling has gradually replaced electrical signaling in telecommunications, that is, transfer of data over long distances. Typical carrier media are single mode optical fibers, multi-mode optical fibers and intermediate fibers such as step index and graded multi-mode fibers with up to 10 Gb/s data transfers even over long distance. With respect to energy efficiency and signal attenuation, optical transmission is far superior to electrical transmission since coating of the fibers with a material of a lower refractive index (cladding) causes total reflection of light inside the fiber, meaning that there is essentially no loss. In addition, optical fibers allow for simultaneous transmission of light-based signals using multiple wavelengths, wherein the different signals are multiplexed and de-multiplexed using wavelength division multiplexing according to several different standards such as dense or coarse wavelength division multiplexing.

LEDs (light emitting diodes) and photodiodes have been miniaturized recently to the point where it has become possible to integrate them onto IC chips. According to a particular aspect of the invention, memory devices and their associated controllers can make use of nanoscale LEDs, photodiodes/phototransistors and/or other evolving optical technologies to replace conventional I/O pins as an alternative to conventional electrical signaling in chip-to-chip data transmission, thereby eliminating the need for the electrical traces connecting transmitters and receivers of the memory devices 12 to the controller 16 of FIG. 1. In doing this, a more simplified design can be achieved that greatly reduces the footprint and design complexity of a multi-chip mass storage device. This approach can be used with any integrated circuit and may be of high value for multi-IC configurations, for example a solid state drive having a plurality of solid state memory devices, including flash memory (particularly NAND flash) and other solid-state memory technologies.

As discussed below, preferred embodiments of the invention can make use of one or more memory devices, including multiple memory devices that can be arranged in an array or stacked to form a three-dimensional memory structure. Each memory device can be adapted to receive commands and addresses from a memory controller via a respective bus, which can comprise separate or serial links carrying packetized command/address structures. Command and address receivers can use electrical signals, though it is also within the scope of the invention that command and address receivers may use optical signals. Each memory device may have its own chip select line to turn on the transmitters and receivers.

According to a particular aspect of the invention, each memory device utilizes I/O data paths that transmit optical data signals. For this purpose, each parallel input/output data connection of the memory controller and each memory device has means for transmitting and receiving optical data signals, for example, LEDs and photodiodes or phototransistors for, respectively, transmitting and receiving optical data signals. The controller further includes a translation layer to convert logical addresses generated by a host computer into physical memory addresses on the memory devices.

According to another aspect of the invention, all optical data signals of each memory device are multiplexed into one optical composite signal using wavelength division multiplexing, yielding what may be termed a multiplexed optical data signal. Accordingly, each memory device can have a private optical I/O link to a memory controller for multiplexed transfer of all data I/O signals via one common optical link. Alternatively, two memory devices can face a multiplexer/de-multiplexer layer in a clamshell configuration with each I/O on either memory device having its own wavelength domain. Accordingly, using two memory devices with eight I/Os each, sixteen I/O paths can be routed simultaneously to a controller through a multiplexed optical data signal transmitted over a single optical I/O link. This optical data signal can be split into the individual optical data signals and converted into electrical signals using a terminal de-multiplexer. Optical links used with the invention can use a bi-directional optical fiber or two separate fibers for full duplex operation.

Another aspect of the invention is for all corresponding I/O data signals of all memory devices that make up an array of memory devices or a subset thereof to use a common optical I/O link, and optical data signals from each memory device can be separated by wavelength division multiplexing. With this approach, each memory device preferably has a specific wavelength assigned. As a result, each optical I/O link can transfer more than one optical data signal in parallel. For example, using coarse wavelength division multiplexing, sixteen signals can be transmitted simultaneously through a single optical fiber. At the controller end, a terminal de-multiplexer can be used to split a multiplexed optical data signal transmitted over an optical I/O link into individual optical data signals and convert these optical data signals into electrical signals that can be distributed over the individual channels of the controller. As a nonlimiting example, in a stack of sixteen memory devices having eight I/Os connections per memory device, 128 bits per transaction can be routed through eight optical channels between the controller and each individual memory device operatively connected to the controller.

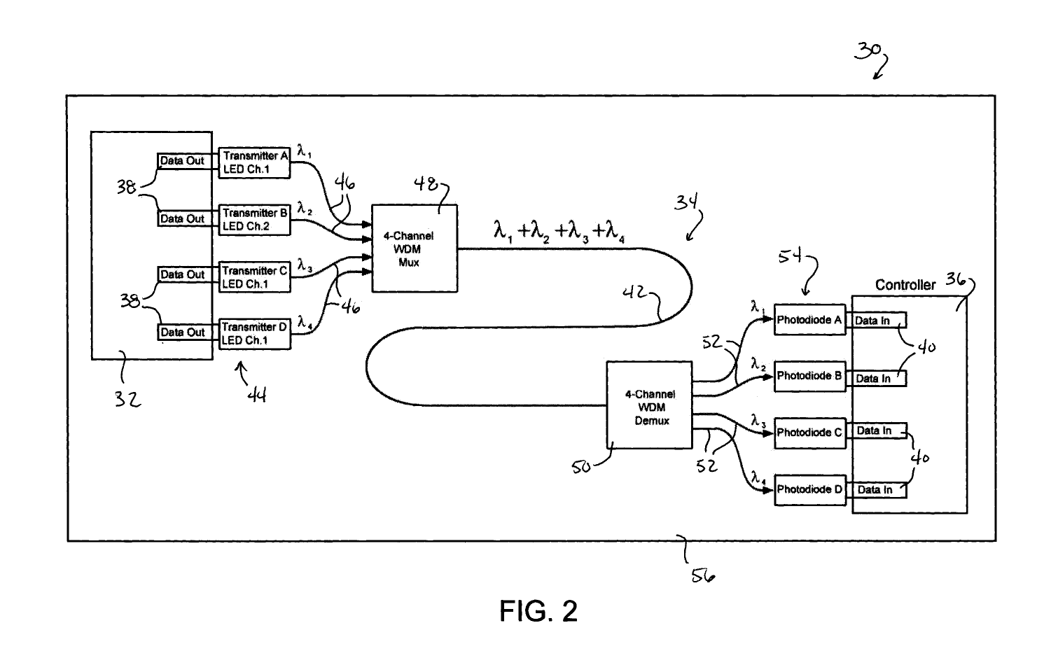

FIGS. 2 through 5 are intended to schematically represent examples of various aspects of the invention discussed above. In FIG. 2, a solid state memory-based mass storage device 30 is schematically represented as being equipped with an optical link (signaling path) 34 adapted for transmitting optical signals between at least one memory device 32 and a memory controller 36. It should be pointed out that, for illustrative purposes, FIG. 2 does not include a reverse signaling path (optical link) that would also be present between the memory controller 36 and the memory device 32 for transmitting optical signals in the opposite direction, in other words, from the controller 36 to the memory device 32. The memory device 32 and controller 36 are represented as being mounted on a carrier board 56 (or other suitable substrate), which can be provided with a suitable system interface connector (not shown) through which the memory controller 46 connects the memory device 32 to a host system (not shown). The memory device 32 and controller 36 are further represented as having parallel input/output data connections (pins) 38 and 40 that are connected to off-chip optical transmitters 44 and receivers 54, respectively. For example, each of the parallel data pins 38 of the memory device 32 is connected to one of the optical transmitters (for example, an LED) 44, which generates an optical signal at a specific wave length (λ₁, λ₂, λ₃, or λ₄) on its own channel 46 connected to a wavelength division multiplexer 48. The multiplexer 48 is represented as generating a single multiplexed optical data signal containing all wavelengths that are transmitted via the optical link 34, represented as comprising a single optical fiber 42. The optical link 34 terminates at a wavelength division demultiplexer 50, where the multiplexed optical data signal is split into individual input/output optical data signals having the wavelengths (λ₁₋₄) of the original data signals generated by the memory device 32. The optical data signals are then individual transmitted via a separate channel 52 to the optical receivers 54 (for example, photodiodes or phototransistors), which are connected to the parallel data pins 40 of the memory controller 36. Each wavelength in this case corresponds to one distinct data signal. Another possibility for simultaneous transmission of multiple signals over a single optical fiber 42 is to use polarization division multiplexing, in which case each polarization plane of a beam of light would correspond to a discrete signal channel. It should be noted that, as implemented, the optical transmitters 44 of the memory device 32 would be complemented by optical receivers 54 and the optical receivers 54 of the controller 36 would be complemented by optical transmitters 44 for operation in combination with the reverse optical link (not shown) that transmits optical signals from the controller 36 to the memory device 32.

A challenge with optical signaling is the injection of light into the fiber 42, since it requires precision alignment of the optical fiber 42 and a light source (transmitter/LED 44). However, it is possible to align multiple individual LEDs 44 with a single optical fiber 42, for example, with a multiplexer 48 that makes use of the dispersion effect of a prism in the reverse direction. By using the chromatic aberration of light, beams of light at different wavelengths entering a prism multiplexer 48 at different angles can be combined into a single composite optical data signal that can be aligned with and transmitted via the optical fiber 42 in FIG. 2. An alternative possibility is to use a collimator to bundle light coming from different directions into a common beam transmitted to the optical fiber 42. A third possibility is to combine multiple optical signals into a common wavelength division multiplexing (WDM) signal and use an arrayed waveguide grating (AWG) module to transmit the composite optical data signal to the optical fiber 42.

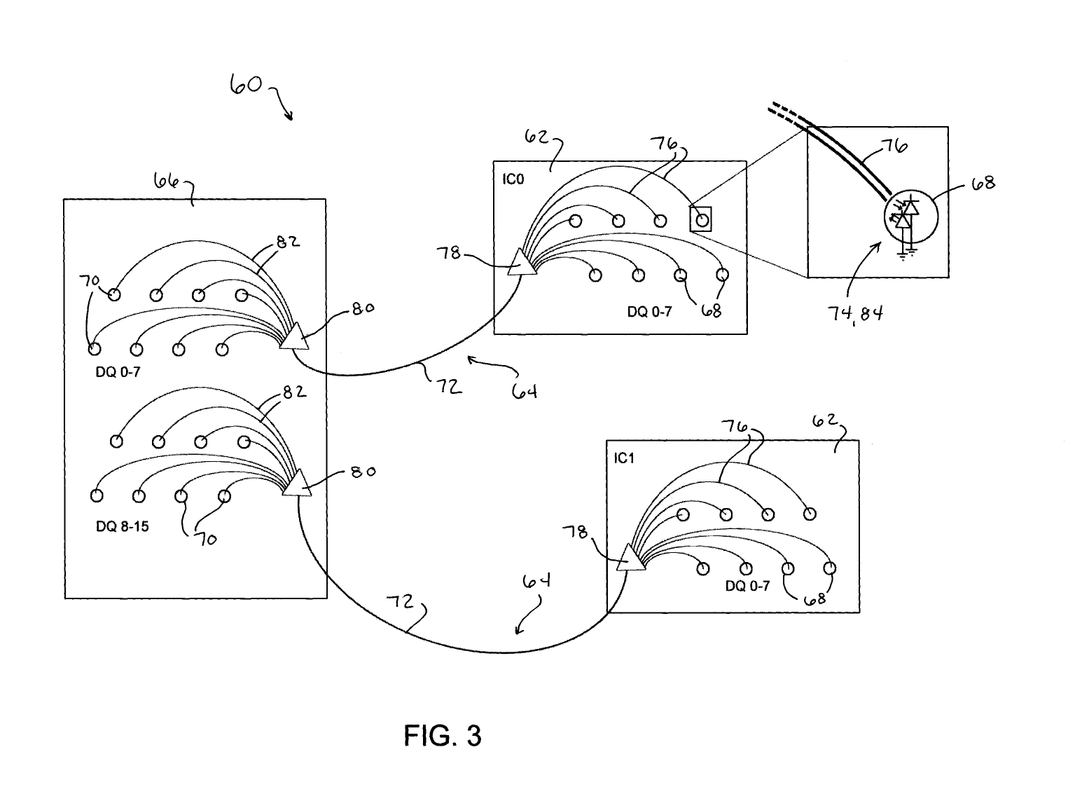

FIG. 3 schematically represents a solid state memory-based mass storage device 60 illustrating another aspect of the invention, in which each I/O pin of a memory device 62 and each I/O pin of the controller 66 is replaced by a pair of integrated (on-chip) optical transmitter (LED) 74 and optical receiver (photodiode, phototransistor or any other light-sensing element) 84, each combination of which constitutes a parallel input/output data connection 68 or 70 of the memory device 62 or controller 66. The light output generated by each LED 74 is routed through a primary optical fiber 76 to an optical interface, represented as a prism 78 in FIG. 3. While passing through the prism 78, the light is refracted at an angle specific to the wavelength of the light generated by the LED. Consequently, light of different wavelengths entering the prism 78 at different angles can be aligned to a single output at an aperture at the opposite side of the prism 78. Likewise, different optical signals spanning the same wavelength spectrum but entering the prism 78 at different angles can be broken down into different wavelength components at an exit aperture. Alternatively, other WDM multiplexers such as AWG modules may be used.

While the embodiment of FIG. 2 is represented as exclusively using off-chip optical transmitters 44 and receivers 54 and the embodiment of FIG. 3 is represented as exclusively using on-chip optical transmitters 74 and receivers 84, the invention encompasses the use of any combination of integrated (on-chip) optical transceivers (FIG. 3) and off-chip optical transceivers connected to conventional I/O pins (FIG. 2) on memory devices and/or memory controllers, and whether one approach or the other is preferred will depend on the specific implementation.

The light exiting the prism 78 (or AWG module) is an aligned composite optical data signal of multiple wavelengths, which is represented in FIG. 3 as being injected into one of two optical fibers 72 that make up an optical signaling path 64 for the memory devices 62. Depending on the desired orientation of the optical fiber 72, a nano-scale mirror (not shown) can be used to re-direct the light into a desired orientation. Alternatively, a secondary prism (not shown) with entrance and exit faces aligned in normal orientation to the beam of light can be used to reflect the light into the desired direction without inducing additional dispersion.

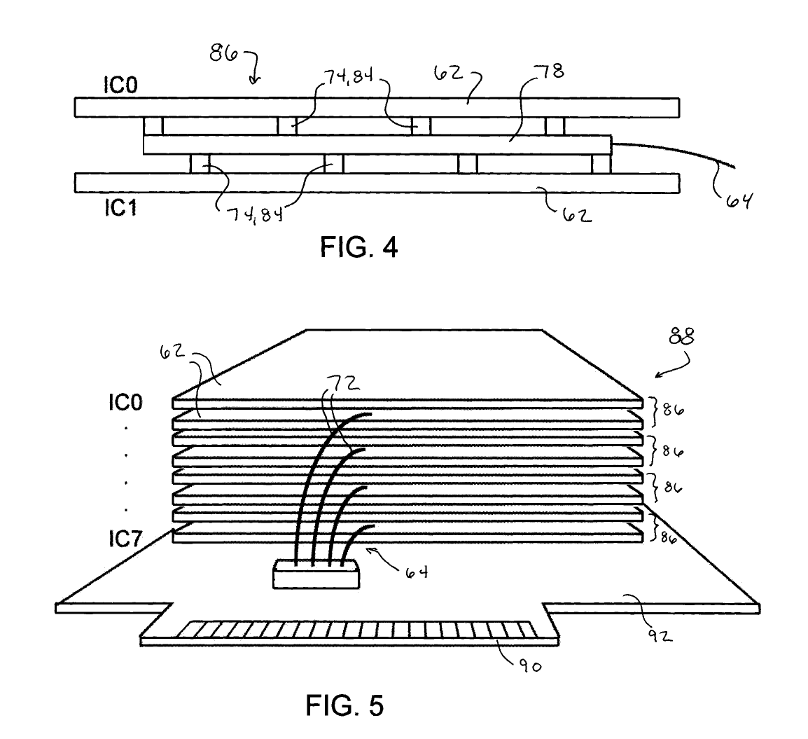

While an optical interface (prism 78) can be integrated with each memory device 62, it may also be a separate layer apposed to the memory device 62, featuring the same number of primary optical fibers 76 for input and output as the number of optical transmitters 74 and receivers 84 associated with each I/O data connection 68. However, for the purpose of higher integration, it is also conceivable that the two memory devices 62 represented in FIG. 3 could be mounted in a three-dimensional clamshell configuration, discussed in reference to FIGS. 4 and 5. For convenience, identical reference numerals are used in FIGS. 4 and 5 to denote the same or functionally equivalent elements described for the storage device 60 of FIG. 3.

As represented in FIG. 4, a three-dimensional memory structure 86 having what is defined herein as a clamshell configuration can be created, in which the memory devices 62 face each other with an optical interface substrate (containing, for example, one or more prisms) 78 sandwiched therebetween. In the case of memory devices 62 with eight I/O pins (not shown), the configuration of FIG. 4 would yield sixteen primary I/O optical fibers (not shown) converging into a single “global I/O” optical I/O link 64, which is capable of transferring sixteen signals simultaneously, each at its own dedicated wavelength. Depending on the size and spacing of the transmitters (LEDs) 74 and receivers (photodiodes) 84, separate primary optical fibers may be necessary. However, it is foreseeable that a single, bi-directional optical fiber could be used as the optical I/O link 64 for both data signal inputs and outputs of the memory devices 62. This embodiment also has the advantage of synchronized signals across all I/O optical paths of one or two memory devices 62 without skew between the individual I/O signals.

Clamshell configurations of the type represented in FIG. 4 allow for the use of multiple optical interface substrates 78 that are similar or identical to each other, can be manufactured independent of the memory devices 62, and can be aligned with the latter as part of the packaging process. The result is a relatively easy implementation, which is independent of the number of memory devices 62 used in the three-dimensional stack. FIG. 5 represents such a three-dimensional stack 88 as including four clamshell memory structures 86, each comprising two memory devices 62 and each interfacing with a system interface connector 90 of a carrier board 92 through an optical signaling path 64 comprising four WDM links 72.

According to another aspect of the invention, it may be advantageous to combine the optical data signals of the corresponding I/O pins of every memory device 62 in the three-dimensional stack 88. In this case, an optical interface can be used to interface with inputs/outputs I/O0, I/O1, I/O2 and so on of all memory devices 62 in the stack 88, and combine the totals into a single multiplexed I/O data signal. As noted above, the optical interface can either constitute two fibers in full duplex mode or a single fiber that uses bi-directional transmissions for input and output data signals.

According to yet another aspect of the invention, the I/Os of multiple memory devices may use conventional electrical signals that connect to an optical multiplexer/de-multiplexer equipped with LEDs and photodiodes, regardless of whether it is a single device interface or a combined interface for two devices in a clamshell configuration. The optical interface can also be used to provide spacing of the individual memory devices for the purpose of cooling, regardless of which interface configuration is used.

In each of the embodiments discussed above, an electrical output signal generated by the I/O driver circuitry of a controller (36, 66) and each memory device (32, 62) can be converted into an optical data signal via a small-scale LED (44, 74), and the optical data signals can be converted back into electrical signals by a photodiode, phototransistor or other photosensor (54, 84). As such, a particular aspect of the invention encompasses a technique that uses optical data signals to connect the data path of a memory controller to the data path of a memory device, wherein each I/O data connection (38, 68) on the memory device (32, 62) operates at a specific wavelength that corresponds to the same wavelength used by an I/O data connection (40, 70) on the controller (36, 66), and the number of individual data channels can be combined into a single optical link using wavelength division multiplexing for identification and separation of individual optical data signals.

It is worth noting that, in the case of telecommunications, optical signaling typically relies on light in the infrared spectrum because of its lower attenuation over long distances. In contrast, for purposes of implementing the present invention, signal attenuation over distance will play a minor role. As such, optical signals with relatively shorter wavelengths, for example, light in the visible spectrum, can be used with the additional benefit of higher refractive indices which may result in better spatial separation of the individual wavelength components converging into a common composite optical data signal. In addition, moving from the infrared spectrum towards visible light or even shorter wavelengths can eliminate the need for temperature control of an optical link (fiber) to avoid interference with the optical data signal from heat generated by the memory devices, controller, or any other component in the system. Likewise, a higher spread of the frequencies of the optical data signals used may allow better separation of the different wavelengths in the common multiplexed optical data signal.

For high speed interconnects to the system, the optical data signals may be converted into low voltage differential signals (LVDS), for example, as used in the current Serial ATA protocol or any other suitable signal. Alternatively, at the system interface it is foreseeable that the optical data signals could be routed directly into a secondary optical interface without conversion into electrical signals.

While the invention has been described in terms of specific embodiments, it is apparent that other forms could be adopted by one skilled in the art. For example, while certain solutions are preferred for the wavelength division multiplexer and demultiplexer used in this invention, it is foreseeable that functionally-equivalent components could be used or subsequently developed to perform the intended functions of the disclosed components. Therefore, the scope of the invention is to be limited only by the following claims.

1. A solid state memory-based mass storage device comprising:
a carrier board including a system interface connector for connecting the carrier board to a host system;
at least one memory device with parallel input/output data connections;
a memory controller having input/output data connections through which the memory controller is connected to the parallel input/output data connections of the memory device;
an optical I/O link that connects the input/output data connections of the memory controller to the parallel input/output data connections of the memory device;
means for generating multiplexed optical data signals that are transmitted across the optical I/O link; and
means for de-multiplexing the multiplexed optical data signals received from the optical I/O link and isolating individual optical data signals therefrom.

2. The solid state memory-based mass storage device of claim 1, wherein the memory device is a non-volatile solid-state memory device.

3. The solid state memory-based mass storage device of claim 1, wherein the generating means performs wavelength division multiplexing to generate the multiplexed optical data signals.

4. The solid state memory-based mass storage device of claim 1, further comprising an optical transmitter for generating optical data signals from which the multiplexed optical data signals are generated by the generating means.

5. The solid state memory-based mass storage device of claim 4, wherein the optical transmitter is a light emitting diode.

6. The solid state memory-based mass storage device of claim 1, further comprising an optical receiver that receives the individual optical data signals from the de-multiplexing means and generates electrical data signals therefrom.

7. The solid state memory-based mass storage device of claim 6, wherein the optical receiver is a photodiode or a phototransistor.

8. The solid state memory-based mass storage device of claim 1, wherein the optical I/O link is a single bidirectional optical link.

9. The solid state memory-based mass storage device of claim 1, wherein the optical I/O link comprises two optical links in full duplex mode.

10. The solid state memory-based mass storage device of claim 1, wherein the memory device is a first memory device, the solid state memory-based device further comprises a second memory device, and the first and second memory devices share the optical I/O link.

11. The solid state memory-based mass storage device of claim 10, wherein the optical I/O link is arranged between the two memory devices in a clamshell configuration.

12. A solid state memory-based mass storage device comprising:
a carrier board including a system interface connector for connecting the carrier board to a host system;
a plurality of non-volatile memory devices each with parallel input/output data connections;
a memory controller having input/output data connections through which the memory controller is connected to the parallel input/output data connections of the memory devices;
means for performing wavelength division multiplexing on parallel input/output optical data signals to generate parallel multiplexed optical data signals;
an optical I/O link that connects the input/output data connections of the memory controller to the parallel input/output data connections of a group of the memory devices and transmits the parallel multiplexed optical data signals between the memory controller and the group of memory devices; and
means for de-multiplexing the parallel multiplexed optical data signals associated with the group of memory devices, isolating individual optical data signals of the parallel multiplexed optical data signals, and distributing the individual optical data signals across parallel input/output data connections on the memory controller.

13. The solid state memory-based mass storage device of claim 12, wherein more than one of the parallel input/output data connections of each memory device of the group of memory devices is connected to the optical I/O link.

14. A method of transferring data between a memory controller and at least one memory device of a solid state memory-based mass storage device, the method comprising:
converting a plurality of electrical output data signals generated by a first of the memory controller and the memory device into optical data signals at different wavelengths;
multiplexing the optical data signals into wavelength division multiplexed signals;
transferring the wavelength division multiplexed signals over an optical I/O link;
de-multiplexing the wavelength division multiplexed signals into individual optical data signals;
converting the individual optical data signals into electrical signals; and
transmitting the electrical signals to a second of the memory controller and the memory device.

15. The method of claim 14, wherein the memory device is one of an array of memory devices functionally connected to the memory controller.

16. The method of claim 15, wherein at least two of the memory devices are arranged in a clamshell configuration and optical data signals of the at least two memory devices are combined in a common wavelength division multiplexed signal that is transmitted over the optical I/O link.

17. The method of claim 15, wherein the optical data signals from more than two memory devices of the array of memory devices are multiplexed into common wavelength division multiplexed signals, and common wavelength division multiplexed signals are de-multiplexed into individual optical data signals transmitted to the more than two memory devices.

18. The method of claim 14, wherein the at least one memory device is a non-volatile solid-state memory device.

19. The method of claim 14, wherein the optical I/O link is a single bidirectional optical link.

20. The method of claim 14, wherein the optical I/O link comprises two optical links in full duplex mode.

21. A solid state memory-based mass storage device comprising:
a carrier board including a system interface connector for connecting the carrier board to a host system;
a plurality of non-volatile memory devices each with parallel input/output data connections;
a memory controller having input/output data connections through which the memory controller is connected to the parallel input/output data connections of the memory devices;
optical transmitters associated with the parallel input/output data connections of the memory devices and the memory controller for generating parallel input/output optical data signals;
means for performing wavelength division multiplexing on the parallel input/output optical data signals to generate parallel multiplexed optical data signals;
an optical I/O link that connects the input/output data connections of the memory controller to the parallel input/output data connections of a group of the memory devices and transmits the parallel multiplexed optical data signals between the memory controller and the group of memory devices;
means for de-multiplexing the parallel multiplexed optical data signals associated with the group of memory devices, isolating individual optical data signals of the parallel multiplexed optical data signals, and distributing the individual optical data signals across parallel input/output data connections on the memory controller; and
optical receivers associated with the parallel input/output data connections of the memory devices and the memory controller for receiving the individual optical data signals from the de-multiplexing means and generating electrical data signals therefrom;
wherein the optical transmitters and receivers are integrated at least on one of the memory devices and the memory controller.

22. A three-dimensional memory structure comprising an optical interface substrate between two memory components, the memory components having integrated optical transmitters and receivers adapted for transmitting and receiving optical signals at specific wavelengths as input/output data connections, the optical interface substrate being configured to combine the specific wavelengths into a wavelength multiplexed common signal transmitted from the memory structure through a common optical link.
